(19) United States
(12) Patent Application Publication
(10) Pub. No.: US 2004/0125055 A1
(43) Pub. Date: Jul. 1, 2004

(54) [ORGANIC LIGHT EMITTING DISPLAY]

(76) Inventor: CHIH-FENG SUNG, MIAOLI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,608

(22) Filed: Dec. 24, 2003

(30) Foreign Application Priority Data
Dec. 25, 2002 (TW) 91137270

(51) Int. Cl. G09G 3/32

(52) U.S. Cl. 345/82

(57) ABSTRACT

An organic light emitting display has a plurality of pixels and an external power line. The external power line diverts into a number of internal power lines connected to the pixels, and the internal power lines are segmented into at least two discontinuous parts. Electric current thereby flows in a smaller amount through the internal power lines to reduce power dissipation.

### CROSS REFERENCE TO RELATED APPLICATIONS

This application claims the priority benefit of Taiwan application serial no. 91137270, filed on Dec. 25, 2002.

### BACKGROUND OF INVENTION

1. Field of Invention

The present invention relates to an organic light emitting display. More particularly, the present invention relates to an active organic light emitting display, in which an external power line has a number of branches as the internal power lines distributed into the pixels, wherein the internal power lines are also separated into at least two parts.

2. Description of Related Art

Movie is the first time to human to observe the image of a moving object. After then, the cathode ray tube (CRT) is invented, and then the TV has been successfully developed and commercialized. And now, TV has been the very common appliance in our daily life for every family. As the scientific technology has been continuously developed, the CRT is also widely used in the computer industry to serving as the terminal for the desk type computer. After a few decades in high popularity, the CRT in various types has encountered the issue of electromagnetic radiation. Also and, due to the structure of electron gun, CRT occupies a lot of space. It is difficult to reduce the volume for satisfying the trend of thin and light properties.

As for the above issues, manufacturers have also endeavored into the development of flat panel display. The filed includes liquid crystal display (LCD), filed emission display (FED), organic light emitting display (OLED), and plasma display panel (PDP).

Wherein, the OLED also called organic electro-luminescence display (OLED), which is a device with spontaneously emitting light. The properties of the OLED includes low driving voltage, high brightness, high efficiency, high contrast, and light, and further the color from three primary colors of red, green, and blue or even the white has wide freedom level. Therefore, the OLED is very expected to be the next generation for the flat panel display and is desired to have great development. The OLED technology can achieve the properties of LCD about lightness, thinness and high resolution, actively emitting light like LED, fast response speed, and low power for the light source, but also it has the advantages, such as wide viewing angle, color contrast effect and low cost. Therefore, the OLED can also have wide applications on serving as a back light source for LCD or indicator, mobile phone, digital camera, and personal digital assistant (PDA).

From the driving method point of view, the OLED can be driven by two categories as the passive matrix driving method and the active matrix driving method. The advantage for the OLED by passive matrix driving method is that the structure is simple and no need of the thin film transistor (TFT) to drive. As a result, the cost is low. However, it has the disadvantages that it is not suitable for use in image with high-resolution. Also and, when the size of the panel is developed in large, the power consumption would increase, the lifetime is reduced, and the displaying quality is poor. For the active matrix driving method, it has the advantages to be capable of applying on a large size of active matrix organic light emitting display (AMOLED). In addition, the wide viewing angle, high brightness, and fast response time are also significant. However, the fabrication cost is slightly greater than that of the passive matrix organic light emitting display.

According to the difference of driving method, the flat panel display can further be divided into voltage driving type and current driving type. The voltage driving type is usually applied on use of TFT-LCD. By feeding different voltage to the data line, the different gray levels can be achieved, so as to have the function of full color. The technology for the voltage driving type is well developed, stable, and low cost. The current driving type usually is applied to the OLED display, in which the different current level is fed to data line to have the different gray level, and achieve the function of full color.

For the AMOLED, since it has a large current to flow through the internal pixel array, and the power lines are usually formed by a thin metal layer, the impedance is then large. Further still, the current flowing through the light emitting device is also not small, the power consumption is rather large. This would easily cause the thermal effect on the panel.

Referring to FIG. 1, it is a drawing, schematically illustrating a simulation of power consumption based on a conventional design of power line in AMOLED. Here, four pixels are taken as an example with an assumption that a current I should flow through each of the four pixels to have the same brightness B. From FIG. 1, the power line can be divided into an external power line 102 and an inner power line 104. The external power line 102 is coupled to the positive power source 106, and the inner power line 104 is divided into four sections. Each of the four sections is assumed to have the impedance R. The situation of power consumption is described as follows. When the current 4I generated by the positive power source 106 flows to the internal power lines 104 through the power line 102, the current 4I flows through the first section 108 of internal power line and the power consumption is P(108)=(4I)² R=16 I²R, and then the current continuously flows to the second section 112 of the internal power line, wherein a portion of current I is flowing to the pixel 110. The power consumption at the second section 112 is P(112)=(3I)² R=9 I²R, and then the current continuously flows to the third section 116 of the internal power line, wherein a portion of current I is flowing to the pixel 114. Likewise, the power consumption at the third section 116 is P(116)=(2I)² R=4 I²R, and then the current continuously flows to the fourth section 120 of the internal power line, wherein a portion of current I is flowing to the pixel 118. The power consumption at the fourth section 120 is P(120)=(I)² R=I²R, and the current I flows through the pixel 122. As a result, the power consumption on the inner power line 104 is P(104)=P(108)+P(112)+P(116)+P(120)=30 I²R, which is rather large.

Another conventional design for the power line for the OLED is also proposed by U.S. Pat. No. 6,380,688. The external power line is separated into a number of sections, so as to reduce power consumption on the external power line but not to reduce the power consumption on the internal power lines. Furthermore, it has many implementations to have the reduction of power consumption on the external power line. For example, the width of the power line is increased, so as to reduce the impedance of the external power line, and then reduce the power consumption on the external power line.

### SUMMARY OF INVENTION

The invention provides an organic light emitting display. The features of the invention include diverting the external power line into a number of internal power lines, and segmenting the internal power lines into parts. This successive diverting and segmentation scheme result in an electric current flowing in a smaller amount through the internal power lines to deliver electric current to the pixels. As a result, electrical dissipation through the internal power lines is reduced.

To achieve the foregoing and other objectives, the invention provides a circuit design of organic light emitting display. The organic light emitting display includes a plurality of pixels and an external power line. The external power line diverts into a plurality of internal power lines, and the internal power lines are separated into parts by a space separation.

In one embodiment of the invention, the external power line is coupled to a positive power source for providing electric current. The electric current flows through the external power line and the internal power lines, so as to provide electric current to the pixels.

In one embodiment of the invention, the pixels are distributed in array.

In one embodiment of the invention, each pixel includes a switching transistor, a driving transistor, a storage capacitor and a light-emitting device. The switching transistor has a first drain electrode, a first gate electrode, and a first source electrode, wherein the first drain electrode is coupled to the data line, and the first gate electrode is coupled to the scan line. The driving transistor has a second drain electrode, a second gate electrode, and a second source electrode, wherein the second gate electrode is coupled to the first source electrode, and the second source electrode is grounded. The storage capacitor has a first terminal and a second terminal, wherein the first terminal is coupled to the first source electrode and the second gate electrode, and the second terminal is grounded and is coupled to the second source electrode. The light-emitting device has an anode and a cathode, wherein the anode is coupled to one of the internal power lines and the cathode is coupled to the second drain electrode. One of the internal power lines is coupled to the positive power source via the external power line. The switching transistor and the driving transistor are thin film transistors, and the light-emitting device is an organic light emitting diode or polymer light emitting diode.

In the embodiment of the invention, the organic light emitting display is an AMOLED.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram simulating the power dissipation of a conventional circuit power line design in an AMOLED.

FIG. 2 is a circuit diagram of an OLED pixel array structure according to one embodiment of this invention.

FIG. 3 is a circuit diagram of a pixel structure according to one embodiment of this invention.

FIG. 4 is a schematic view simulating the power dissipation of a circuit design of power line in an AMOLED according to one embodiment of this invention.

### DETAILED DESCRIPTION

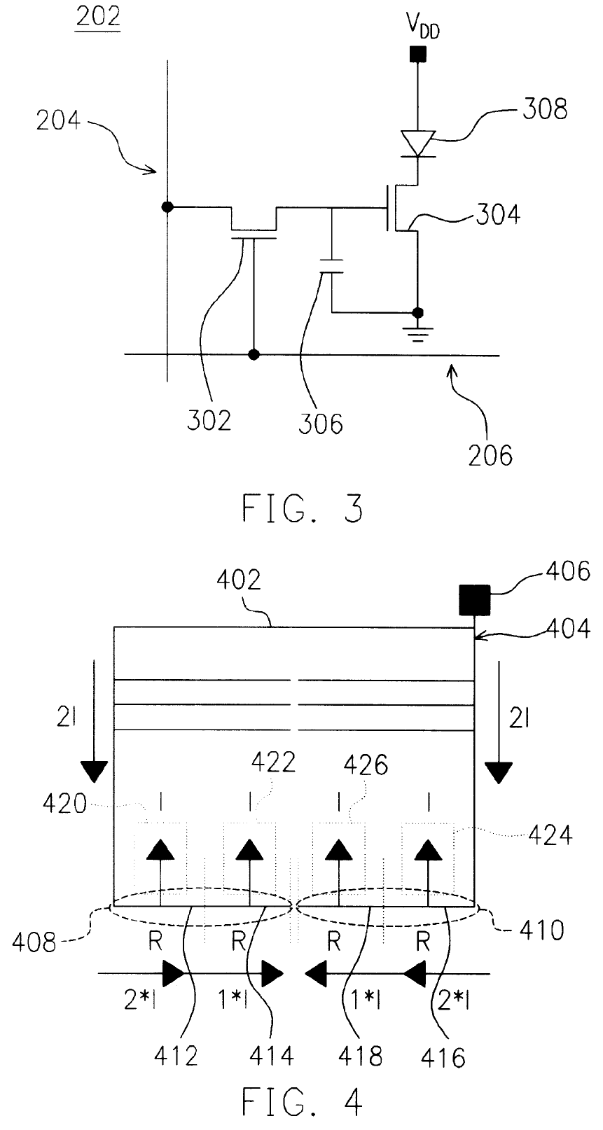

The organic light emitting display (OLED) in the invention is, for example, an active type OLED. FIG. 2 is a schematic view of a general architecture of an OLED pixel array 20 according to one embodiment of this invention. The pixel array 20 includes pixels 202, data lines 204, and scan lines 206. According to an embodiment, the external power line diverts into a number of internal power lines between the pixels. The internal power lines are separated into parts, for example two parts. FIG. 3 is a circuit diagram of a pixel structure according to one embodiment of this invention. The pixel structure 202 includes a switching transistor 302, a driving transistor 304, a storage capacitor 306, and a light-emitting device 308. The switching transistor 302 has a drain electrode, a gate electrode, and a source electrode. The driving transistor 304 has a drain electrode, a gate electrode, and a source electrode. The storage capacitor 306 has a first terminal and a second terminal. The light-emitting device 308 has an anode and a cathode. The drain electrode of the switching transistor 302 is coupled to the data line 204. The gate electrode of the switching transistor 302 is coupled to the scan line 206. The source electrode of the switching transistor 302 is coupled to the gate electrode of the driving transistor 304 and one terminal of the storage capacitor 306. The drain electrode of the driving transistor 304 is coupled to the cathode of the light-emitting device 308 and the source electrode of the driving transistor 304 is grounded and coupled to another terminal of the storage capacitor 306. The anode of the light-emitting device 308 is coupled to one of the internal power lines. The internal power lines are coupled to a positive power voltage Vdd via the external power line. In addition, the switching transistor 302 and the driving transistor 304 are, for example, thin film transistors. The light-emitting device 308 can be an organic light emitting diode or a polymer light emitting diode. The light-emitting device 308 is driven by an electric current to emit light. However, the power for the current flowing through the power lines is still consumed due to the impedance.

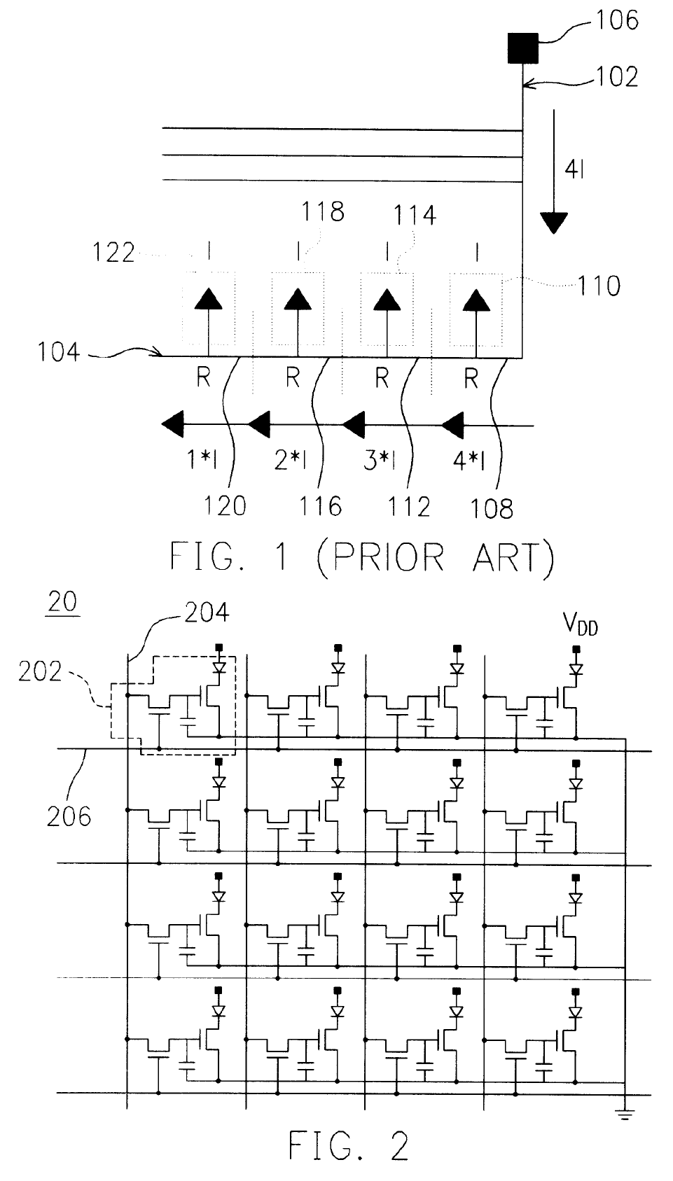

FIG. 4 is a schematic view simulating the power dissipation of an AMOLED circuit design, according to one embodiment of this invention. In FIG. 4, for easy understanding and descriptions of the invention, the internal power lines are separated into two parts. However, the number of sections is not limited to only two sections. Also and, the simulation assumption is the same for the conventional situation shown in FIG. 1, so as to show the difference of the power consumption between the invention and convention. Four pixels are exemplary considered in the simulation. In addition, the light-emitting device of each pixel requires a driving current I to have a brightness B.

The power dissipation of the circuit shown in FIG. 4 is as follows. In FIG. 4, two external power lines 402, 404 divert from common positive power source 406. The two external power lines 402, 404 are located at two sides of the pixels to supply electric current. Since the two external power lines 402, 404 can be very wide, the impedance can be reduced rather low. As a result, electric dissipation induced by the external power lines can be neglected. The internal power lines are separated into two parts, respectively a left-part internal power line 408 and a right-part internal power line 410. The left-part internal power line 408 is further divided into a first section 412 and a second section 414, and the right-part internal power line 410 is divided into a third section 416 and a fourth section 418. Each section is assumed to have an impedance R.

The power dissipation of the left-part internal power line 408 is as follows. While the positive power source 406 generates a current of 4I, a current amount of 2I flows through the external power line 402 and reaches the left-part internal power line 408. The current 2I flows through the first section 412, causing a power dissipation P(412)=(2I)² R=4 I²R in the first section 412 of internal power line, and an amount of current I flows into the pixel 420. The remaining amount of current I then flows through the second section 414 of the power line, dissipating P(414)=(I)² R=I²R, and then a remaining amount of current I flows into the pixel 422. The total power dissipation on the left-part internal power line 408 therefore is P(408)=P(412)+P(414)=5 I²R.

The power dissipation for the right-part internal power line 410 is as follows. While the positive power source 406 generates an electric current 4I, a diverted amount of electric current 2I flows through the external power line 404 and reaches the right-part internal power line 410. The current 2I then flows through the third section 416 of the internal power line dissipating P(416)=(2I)² R=4 I²R, and an amount of electric current I flows into the pixel 424. The remaining electric current I then flows through the fourth section 418 dissipating P(418)=(I)² R=I²R, and supplies an electric current I to the pixel 426. Therefore, the total power dissipation of the right-part internal power line 410 is P(410)=P(416)+P(418)=5 I²R. The total power dissipation on the internal power line is P(408)+P(410)=10 I²R. According to the foregoing scheme, power dissipation on the circuit of FIG. 4 is only one third of the power dissipation of the conventional circuit of FIG. 1. Therefore, the derivation scheme of the invention implemented for the power line can effectively reduce the power consumption.

It should be emphasized that the invention is not limited to separate the internal power line into two parts. The number of parts of internal power line can be 3, 4, 5, or more. When the number of parts is larger, the power consumption is smaller.

In conclusions, the characteristics of the invention are that the external power line is connected to the pixels with a number of internal power lines, and the internal power lines are segmented into many parts. Since the external power line diverts into a number of internal power lines, and the internal power lines are separated into parts, the electric current flows in a substantially smaller amount through the internal power lines. As a result, power dissipation can be improved. In addition, the invention can save the power and can reduce the thermal effect on the panel. The lifetime of the panel is prolonged.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. An organic light-emitting display having a plurality of pixels and at least one external power line, the organic light-emitting display being characterized in that:
the external power line diverts into a plurality of internal power lines to connect to the pixels, wherein each of the internal power lines is segmented into at least two separated parts.

2. The organic light emitting display of claim 1, wherein the external power line is coupled to a power source.

3. The organic light emitting display of claim 2, wherein the power source supplies an electric current, and the electric current flows through the internal power lines to reach the pixels.

4. The organic light emitting display of claim 1, wherein the pixels are arranged in a pixel array.

5. The organic light emitting display of claim 1, wherein each of the pixels comprises:
a switching transistor, having a first drain electrode, a first gate electrode, and a first source electrode, wherein the first drain electrode is coupled to a data line, and the first gate electrode is coupled to a scan line;
a driving transistor, having a second drain electrode, a second gate electrode, and a second source electrode, wherein the second gate electrode is coupled to the first source electrode, and the second source electrode is grounded;
a storage capacitor, having a first terminal and a second terminal, wherein the first terminal is coupled to the first source electrode and the second gate electrode, and the second terminal is grounded and coupled to the second source electrode; and
a light-emitting device, having an anode and a cathode, wherein the anode is coupled to one of the internal power lines and the cathode is coupled to the second drain electrode.

6. The organic light emitting display of claim 5, wherein one terminal of each of the internal power lines is coupled via the external power line to a positive power source.

7. The organic light emitting display of claim 5, wherein the switching transistor comprises a thin film transistor.

8. The organic light emitting display of claim 5, wherein the driving transistor comprises a thin film transistor.

9. The organic light emitting display of claim 5, wherein the light-emitting device comprises an organic light-emitting diode.

10. The organic light emitting display of claim 5, wherein the light-emitting device comprises a polymer light-emitting diode.

11. The organic light emitting display of claim 1, wherein the organic light-emitting device comprises an active matrix organic light emitting display.
